(19) United States
(12) Patent Application Publication
(10) Pub. No.: US 2002/0014330 A1
(43) Pub. Date: Feb. 7, 2002

(54) Device for heating/air-conditioning of the passenger compartment of a motor vehicle

(76) Inventor: Gwenael Guyonvarch, Rambouillet (FR)

Correspondence Address: Matthew W. Stavish, Esq., Liniak, Berenato, Longacre & White, LLC, Suite 240, 6550 Rock Spring Drive, Bethesda, MD, 20817, US

(21) Appl. No.: 09/916,259

(22) Filed: Jul. 30, 2001

(30) Foreign Application Priority Data
Jul. 28, 2000 (FR) 00 09992

(51) Int. Cl. B60H 1/00; F25B 29/00; F25D 17/02

(52) U.S. Cl. 165/202; 165/240; 62/434; 62/435

(57) ABSTRACT

The device of the invention comprises a closed circuit (10) in which a refrigerant fluid circulates between an evaporator (12) and a condenser (14) which are respectively in thermal contact with a cold-liquid duct (22) and a hot-liquid duct (24). Changeover-switching means (34, 36) put these two ducts into communication either with a first loop (26) travelled by a liquid and containing a heat exchanger (28) capable of being swept by an airflow (F1), or with a second loop (38) travelled by a liquid and comprising a heat exchanger (42) suitable for being swept by an airflow (F2) to be sent into the passenger compartment (H) . The heat exchanger (42) of the second loop (38) can thus heat up or cool the airflow (F2).

### FIELD OF THE INVENTION

The invention relates to device for heating/air-conditioning of the passenger compartment of a motor vehicle.

### BACKGROUND OF THE INVENTION

In the majority of the devices of this type, a heating radiator is provided which, most often, is traversed by the fluid for cooling the engine of the vehicle, as well as an evaporator forming part of an air-conditioning circuit travelled by a refrigerant fluid.

The evaporator is generally placed upstream of the heating radiator, in such a way that the same airflow can successively traverse the evaporator and the heating radiator in order to produce an airflow, at regulated temperature, which is sent into the passenger compartment. The airflow is generally sent by means of a variable-speed blower which makes it possible to regulate the speed and the throughput of the airflow sent into the passenger compartment.

In the case in which the heating radiator, also called air heater, is travelled by the engine-cooling fluid, it is mounted in a bypass of this circuit.

It is also known to carry out the heating of the airflow via an electric radiator which can either be substituted for, or added to, the heating radiator travelled by the engine-cooling fluid.

It is known, furthermore, to make use of the refrigerant-fluid circuit to carry out not only the function of cooling or air-conditioning of the passenger compartment, but also the heating function.

In fact, an air-conditioning circuit consists of a closed circuit in which a refrigerant fluid circulates between an evaporator where it passes from the liquid state to the gaseous state, by receiving heat, and a condenser where it passes from the gaseous state to the liquid state by giving up heat. This circuit further comprises a compressor placed between the evaporator and the condenser, and a pressure-reducing valve placed between the condenser and the evaporator.

In a conventional air-conditioning circuit, the evaporator absorbs heat, which makes it possible to send cold or refrigerated air into the passenger compartment.

In contrast, the condenser is generally swept by the same airflow as the engine-cooling radiator, which makes it possible to produce a hot airflow which is dissipated as pure losses.

It is also known to make use of the air-conditioning circuit so as to make it operate in a heating mode, in which the evaporator is made to operate as a condenser, in order to produce heat.

In this case, the same heat exchanger may do the job either of evaporator for producing conditioned air, or of condenser for producing hot air.

In all cases, these heating/air-conditioning devices are of complex structure.

Moreover, in the heating mode, they draw off some of the thermal losses of conventional internal-combustion engines, whereas the modern engines, because of their better efficiency, have reduced thermal losses.

It is then often necessary, in this case, to provide a top-up heating radiator, especially when the heating operates with the engine cold or with a very low outside temperature.

### SUMMARY OF THE INVENTION

The object of the invention is especially to overcome the abovementioned drawbacks.

The invention aims in particular to obtain a heating/air-conditioning device with a simpler structure, and one which can, moreover, function effectively with the modern vehicles driven either by a high-efficiency internal-combustion engine or even by an electric motor.

To that end the invention proposes a device for heating/air-conditioning of the passenger compartment of a motor vehicle, which comprises, in combination:

a closed circuit in which a refrigerant fluid circulates between an evaporator and a condenser;

a cold-liquid duct, called “cold duct”, in thermal contact with the evaporator, and a hot-liquid duct, called “hot duct”, in thermal contact with the condenser;

a first loop travelled by a liquid under the action of a pump and comprising a heat exchanger suitable for being swept by a heat-carrying fluid, especially by an airflow;

a second loop travelled by a liquid under the action of a pump, and comprising a heat exchanger suitable for being swept by an airflow to be sent into the passenger compartment; and

changeover-switching means interposed between the cold duct, the hot duct, the first loop and the second loop, and capable of being placed selectively either into a heating position in which the first loop is in communication with the cold duct, while the second loop is in communication with the hot duct, or into a cooling position in which the first loop is in communication with the hot duct, while the second loop is in communication with the cold duct.

Thus, the heating or the cooling of the passenger compartment is carried out via a heat exchanger which is integrated into a loop travelled by a liquid, this loop possibly being placed in communication selectively either with a hot duct in contact with the condenser, or with a cold duct in contact with the evaporator.

Thus, the temperature of the air sent into the passenger compartment is set by a heat exchanger of the air/liquid type travelled by a liquid (typically water) which is either heated in contact with the condenser, or cooled in contact with the evaporator.

It is thus the closed refrigerant-fluid circuit which makes it possible directly to adjust the temperature of the liquid and, consequently, that of the airflow sent into the passenger compartment.

Thus results in a simplification of manufacture.

In a first embodiment of the invention, the changeover-switching means comprise two four-way valves.

In a variant, these may take the form of two mixer valves, which makes it possible to mix the hot liquid originating from the condenser and the cold liquid originating from the evaporator, in adjustable proportions.

Advantageously, the device comprises a module which includes the refrigerant-fluid closed circuit, as well as the cold duct and the hot duct.

Thus this module advantageously also includes the compressor and the pressure-reducing valve of the refrigerant-fluid circuit.

It is advantageous for this compressor to be electric.

According to another characteristic of the invention, the device comprises a blower associated with the heat exchanger of the second loop for sending into the passenger compartment an airflow having swept over this heat exchanger.

An additional radiator may be provided, moreover, suitable for being heated by the engine of the vehicle, this additional radiator being arranged in proximity to the heat exchanger of the second loop in such a way as to be traversed by the same airflow sent into the passenger compartment.

It is advantageous for the second loop additionally to comprise at least one supplementary heat exchanger travelled by the same liquid.

This may, for example, be an exchanger integrated into a seat of the vehicle or else an exchanger integrated into a panel.

The heat exchanger of the first loop is preferably separate from the radiator for cooling the engine of the vehicle.

Clearly, it is also possible for this heat exchanger to be integrated into the radiator for cooling the engine of the vehicle.

### BRIEF DESCRIPTION OF THE DRAWINGS

In the description which follows, given solely by way of example, reference is made to the attached drawings, in which:

FIG. 1 is a diagrammatic view of a device for heating/air-conditioning of the passenger compartment of a motor vehicle according to the invention, represented in a heating position;

FIG. 2 is a view similar to FIG. 1 in which the device is represented in a cooling position; and

FIG. 3 is a diagrammatic representation of a heating/air-conditioning device in a variant embodiment.

### DESCRIPTION OF THE PREFERRED EMBODIMENTS

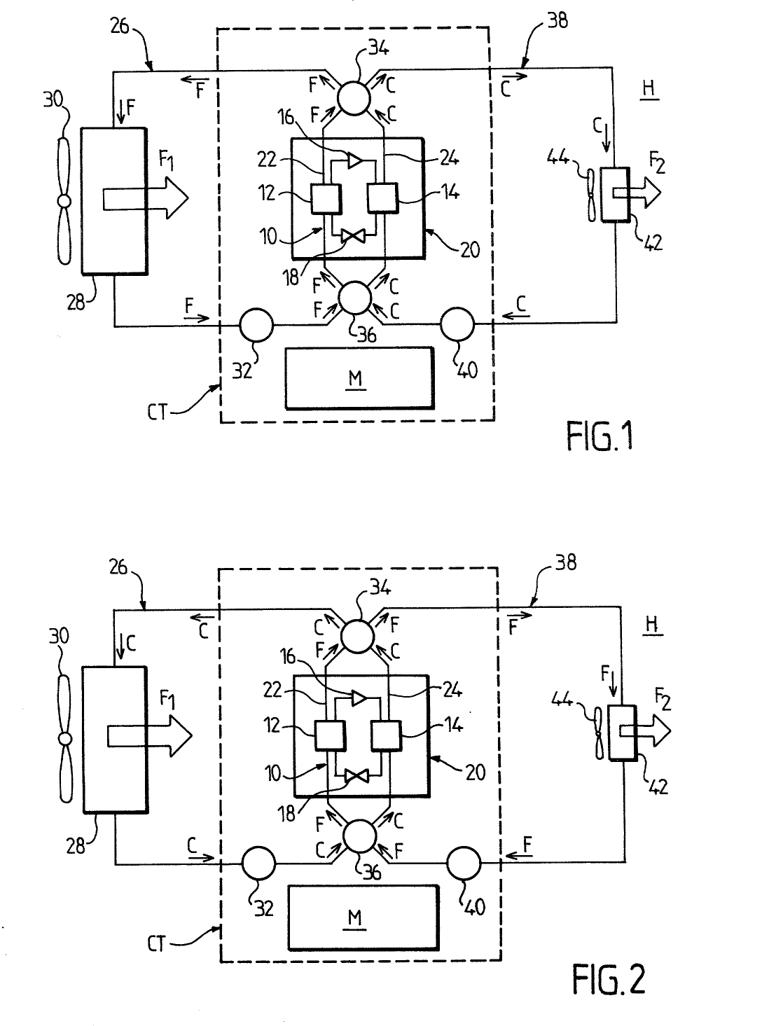

The heating/air-conditioning device represented diagrammatically in FIG. 1 is intended for heating of the passenger compartment H of a motor vehicle. It comprises a closed circuit 10 travelled by a refrigerant fluid which circulates between an evaporator 12 where it passes from the liquid state to the gaseous state by receiving heat, and a condenser 14 where it passes from the gaseous state to the liquid state by giving up heat. This closed circuit further comprises a compressor 16 placed between the evaporator 12 and the condenser 14, and a pressure-reducing valve 18 placed between the condenser 14 and the evaporator 12. Thus a closed circuit is constituted, also called air-conditioning circuit, in which the evaporator absorbs heat and “produces cold”, while the condenser gives up heat and “produces heat”.

This closed circuit may further comprise a filtering/dehydrating bottle, an internal exchanger, an accumulator, pressure-sensitive switches, temperature sensors, etc.

The refrigerant fluid may, for example, be the fluid known by the name of “R134a”, carbon dioxide, a hydrocarbon, etc.

In accordance with the invention, the closed circuit 10 is housed within a module 20 which is itself arranged within an equipment compartment CT separate from the passenger compartment H of the vehicle.

In the module 20, moreover, are placed two liquid ducts, namely a cold duct 22 which is in thermal contact with the evaporator 12 and a hot duct 24 which is in thermal contact with the condenser 14.

The device further comprises a first loop 26 which is situated outside the equipment compartment CT and which is intended to be travelled by a liquid. This first loop incorporates a heat exchanger 28 (radiator) with which a motor-driven fan unit 30 is associated, as well as a liquid-circulation pump 32, which is advantageously an electric pump. The radiator 28, in this example, is separate from the radiator (not represented) serving for the cooling of the engine M of the vehicle. The motor-driven fan unit 30 makes it possible to blow an airflow (arrow F1) which sweeps over the heat exchanger 28 so as, if necessary, to cool the liquid circulating in the loop 26.

The loop 26 is linked to the ducts 22 and 24 by two valves 34 and 36 of the four-way type.

These two valves are also linked to a second loop 38 travelled by a liquid under the action of a pump 40, which is advantageously an electric pump. The loop 38 comprises a heat exchanger 42 with which a blower 44 is associated. This blower makes it possible to send an air-flow into the passenger compartment H after having traversed the exchanger 42 as shown by the arrow F2. The heat exchanger 42 is of the air/liquid type.

The valves 34 and 36 may be brought selectively into two different positions, namely a heating position as represented in FIG. 1 and a cooling position (or air-conditioning position) as represented in FIG. 2. In the position of FIG. 1, the valves 34 and 36 put the hot duct 24 into fluid communication with the loop 38, thus with the exchanger 42, on the one hand, and the cold duct 22 into fluid communication with the loop 26, on the other hand.

It results therefrom that the exchanger 42 is travelled by a hot liquid (heated up by the condenser 14), which makes it possible to send a hot airflow into the passenger compartment. In contrast, the loop 26 is travelled by a cold liquid.

The circulation of the hot liquid is represented by the arrows C and that of the cold liquid by the arrows F in FIG. 1.

The throughput of the hot liquid in the loop 38 can be adjusted by varying the speed of the pump 40.

In the cooling position (or air-conditioning position) of FIG. 2, the valves 34 and 36 put the loop 38 into communication with the cold duct 22, so that the exchanger 42 is travelled by a cold liquid, which makes it possible to cool or refrigerate the passenger compartment of the vehicle. At the same time, these valves put the hot duct 24 into communication with the loop 26, so that the radiator 28 is travelled by a hot fluid. It is then advantageous to start up the motor-driven fan unit 30 in order to dissipate the surplus heat transported by the hot liquid.

As in FIG. 1, the circulation of the hot liquid is represented by the arrows C and that of the cold liquid by the arrows F.

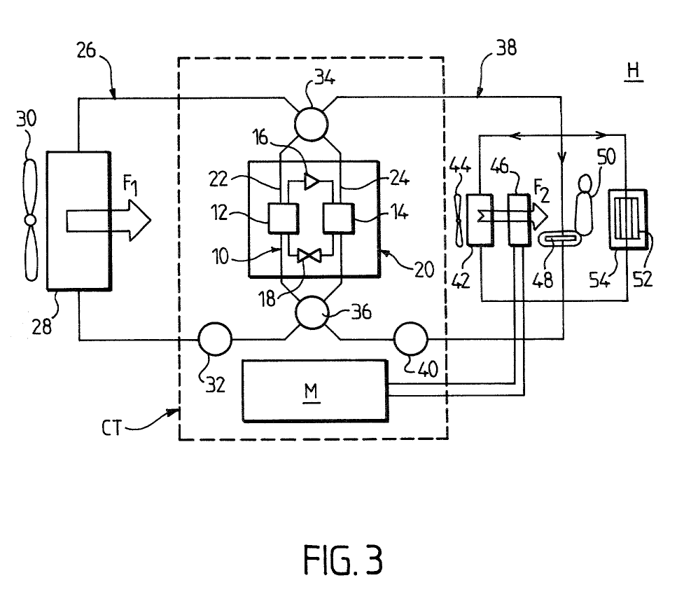

In the embodiment of FIG. 3, the elements which are common with those of FIGS. 1 and 2 are designated by the same numerical references.

In this embodiment variant, an additional radiator 46 is additionally provided, which is arranged in proximity to the heat exchanger 42 so that the airflow, put into motion by the blower 44, successively traverses the exchanger 42 and the additional radiator 46.

In the example, this additional radiator is able to be heated up by the engine M of the vehicle and, if appropriate, by auxiliary units of the said engine.

This additional radiator may serve either to supply top-up heat when the exchanger 42 is functioning in heating mode, or to re-heat an airflow which has previously been dehumidified by the exchanger 42, when the latter is functioning in cooling mode. It is also possible to add an electric radiator.

In the embodiment represented, it will be noted, moreover, that the second loop comprises two other supplementary heat exchangers, namely an exchanger 48 integrated into at least one seat 50 of the vehicle and an exchanger 52 integrated into a panel 54.

In the various abovementioned embodiments, the radiator 28 is advantageously separate from the engine-cooling radiator, but could, in a variant, form part of it.

Also in a variant, the valves 34 and 36, instead of being four-way valves, could consist of mixer valves in order to send, into the circuit 38, a liquid resulting from the mixing of a cold liquid and of a hot liquid.

The pumps 32 and 40 are advantageously electric pumps, the speed of which can be adjusted at will.

According to the invention, the liquid which circulates in the two loops 26 and 38 and in the ducts 22 and 24 is advantageously water with an antifreeze added, for example glycol.

Needless to say, the invention is not limited to the embodiment described above by way of example, and extends to other variants.

1. Device for heating/air-conditioning of the passenger compartment of a motor vehicle, characterised in that it comprises, in combination:
a closed circuit in which a refrigerant fluid circulates between an evaporator and a condenser;
a cold-liquid duct (22) , called “cold duct”, in thermal contact with the evaporator (12), and a hot-liquid duct (24) , called “hot duct”, in thermal contact with the condenser (14);
a first loop (26) travelled by a liquid under the action of a pump (32) and comprising a heat exchanger (28) suitable for being swept by a heat-carrying fluid, especially by an airflow (F1);
a second loop (38) travelled by a liquid under the action of a pump (40), and comprising a heat exchanger (42) suitable for being swept by an airflow (F2) to be sent into the passenger compartment (H); and
changeover-switching means comprising two four-way valves (34, 36) , interposed between the cold duct, the hot duct, the first loop and the second loop, and capable of being placed selectively either into a heating position in which the first loop (26) is in communication with the cold duct (22), while the second loop (38) is in communication with the hot duct (24), or into a cooling position in which the first loop (26) is in communication with the hot duct (24), while the second loop (38) is in communication with the cold duct (22).

2. Device according to claim 1, characterised in that the changeover-switching means comprise two mixer valves.

3. Device according to claim 1, characterised in that it comprises a module (20) which includes the refrigerant-fluid closed circuit (10), as well as the cold duct (22) and the hot duct (24).

4. Device according to claim 1, in which the refrigerant-fluid closed circuit (10) further comprises a compressor (16), characterised in that this compressor is electric.

5. Device according to claim 1, characterised in that it comprises a blower (44) associated with the heat exchanger (42) of the second loop (38) for sending into the passenger compartment (H) an airflow (F2) having swept over this heat exchanger.

6. Device according to claim 1, characterised in that it further comprises an additional radiator (46) suitable for being heated by the engine (M) of the vehicle, the said additional radiator being arranged in proximity to the heat exchanger (42) of the second loop in such a way as to be traversed by the same airflow (F2) sent into the passenger compartment (H).

7. Device according to claim 1, characterised in that the second loop (38) additionally comprises at least one supplementary heat exchanger (48, 52) travelled by the same liquid.

8. Device according to claim 7, characterised in that the supplementary heat exchanger (48) is integrated into a seat (50) of the vehicle.

9. Device according to claim 7, characterised in that the supplementary heat exchanger (52) is integrated into a panel (54).

10. Device according to claim 1, characterised in that the heat exchanger (28) of the first loop (26) is separate from the radiator for cooling the engine (M) of the vehicle.
